(19) United States
(12) Patent Application Publication
(10) Pub. No.: US 2005/0284521 A1
(43) Pub. Date: Dec. 29, 2005

(54) Auto-drain valve of air compressor

(76) Inventor: Tu-Chiang Chang, Changhua (TW)

Correspondence Address: Tu-Chiang Chang, 235 Chung-Ho, Box 8-24, Taipei, TW

(21) Appl. No.: 10/873,448

(22) Filed: Jun. 23, 2004

(51) Int. Cl. F16K 17/30

(52) U.S. Cl. 137/517

(57) ABSTRACT

An auto-drain valve of an air compressor is installed at a lower end of an air compressor for draining wasted water within the air compressor. The auto-drain valve comprises a retaining ring locked at the lower end of the air compressor. A receiving ring is locked to the retaining ring. An inner surface of the receiving ring is formed with a stepped edge. A check unit is received within the retaining ring and the receiving ring. The stepped edge of the receiving ring serves for confining the check unit; one end of the check unit is protruded with a small annular surface. A spring is arranged within the small annular surface. A water-stop washer is formed upon the stepped edge. A check disk is placed above the small annular surface; and a pressure accumulating groove is formed at an upper side of the check disk.

### FIELD OF THE INVENTION

The present invention relates to air compressors, and particular to an auto-drain valve of an air compressor. The present invention has a simple structure, can be installed easily. The draining of the air compressor B is performed automatically without using electric power.

### BACKGROUND OF THE INVENTION

Each time air inputs or outputs from an air compressor, impurities or oil or vapors are accumulated in the storage tank of the air compressor. After a time period, the accumulated impurities and water will be drained out. In the conventional auto-draining device of an air compressor, a ball valve is connected below the storage tank. When the air compressor is not used, the ball valve is opened for drainage, removing impurities and wasted waters. However, the operation is inconvenient and tedious. Thereby, a level senor or a pressure sensor is used to determine the actuation of the ball valve, but the draining holes of the servo valve is very small so as to be sealed in the draining process. Thereby, the fault rate of the servo valve is very high so that the cost is increased.

### SUMMARY OF THE INVENTION

Accordingly, the primary object of the present invention is to provide an auto-drain valve of an air compressor which is installed at a lower end of an air compressor for draining wasted water within the air compressor. The auto-drain valve comprises a retaining ring locked at the lower end of the air compressor. A receiving ring is locked to the retaining ring. An inner surface of the receiving ring is formed with a stepped edge. A check unit is received within the retaining ring and the receiving ring. The stepped edge of the receiving ring serves for confining the check unit; one end of the check unit is protruded with a small annular surface. A spring is arranged within the small annular surface. A water-stop washer is formed upon the stepped edge. A check disk is placed above the small annular surface; and a pressure accumulating groove being formed at an upper side of the check disk.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is a plan cross section view showing the structure for stopping air from drainage according to the present invention.

FIG. 4 is a plan cross section view showing the drainage operation of the present invention.

FIG. 5 shows one embodiment of embodiment, where the present invention is assembled to a lower end of an air compressor.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

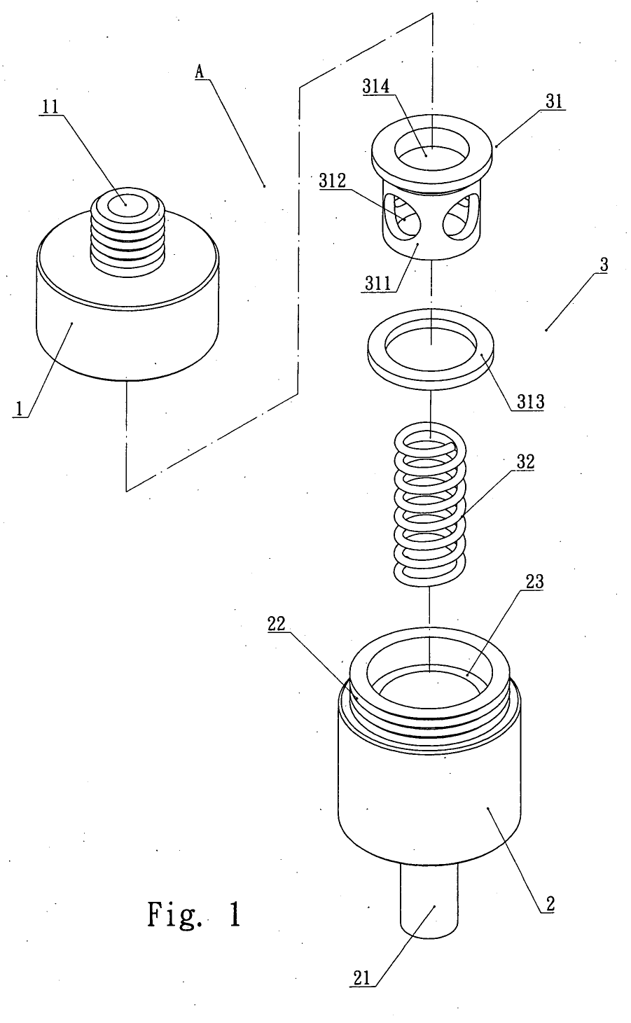

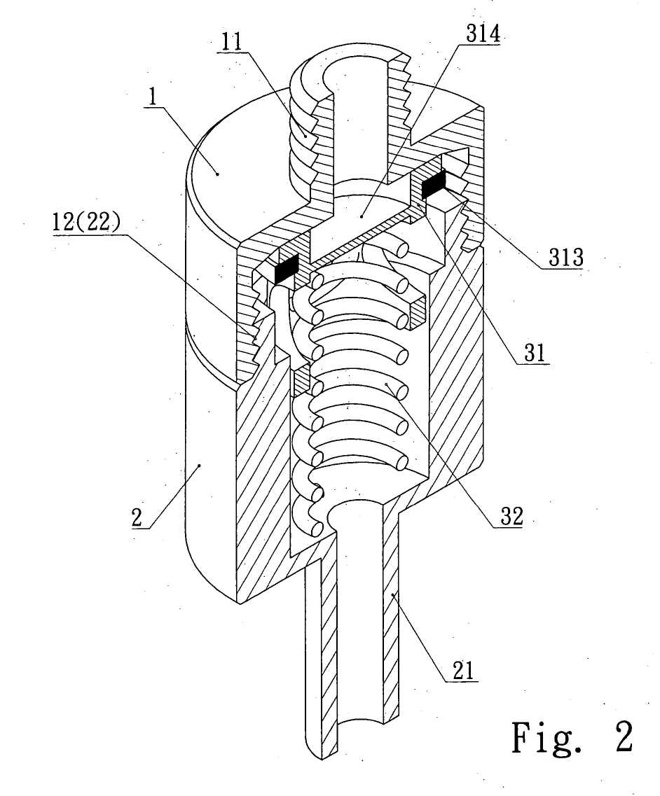

With reference to FIGS. 1 and 2, the auto-drain valve of an air compressor of the present invention is clearly illustrated. The auto-drain valve of an air compressor has the following elements.

A drain valve A is installed at a lower end of an air compressor B for draining wasted water within the air compressor B. The drain valve A is formed by a retaining ring 1, a receiving ring 2 and a check unit 3.

The retaining ring 1 is locked at the lower end of the air compressor B. One end of the retaining ring 1 is protruded with a threaded section 11. Thereby, one end portion of the retaining ring 1 can be locked to a lower end of an air compressor. An inner surface of the retaining ring 1 has female threaded surface 12 for locking the receiving ring 2.

The receiving ring 2 is locked to a lower end of the retaining ring 1. One end portion of the receiving ring 2 is extended with a water outlet 21. An outer surface of another end of the receiving ring 2 has a male threaded surface 22 for engaging with the female threaded surface 12 of the retaining ring 1. An inner surface of the receiving ring 2 is formed with a stepped edge 23.

The check unit 3 is received within the retaining ring 1 and the receiving ring 2. The stepped edge 23 of the receiving ring 2 serves for confining the check unit 3 as a pressure is applied to the check unit 3. One end of the check unit 3 is protruded with a small annular surface 311. A spring 32 is arranged within the small annular surface 311. A through hole 312 for passing wasted water is formed in the small annular surface 311. A water-stop washer 313 is formed upon the stepped edge 23. A check disk 31 is placed above the small annular surface 311. A pressure accumulating groove 314 is formed at an upper side of the check disk 31. The pressure accumulating groove 314 and the inner space of the retaining ring 1 are formed with a closed space. When the air pressure within the air compressor B is greater than resisting force of the spring 32, the air pressure in the air compressor B can compress the spring 32. Meanwhile, the water-stop washer 313 of the check disk 31 is pressed by the spring 32 so as to resist against the stepped edge 23 of the receiving ring 2 for preventing air in the air compressor B from draining out.

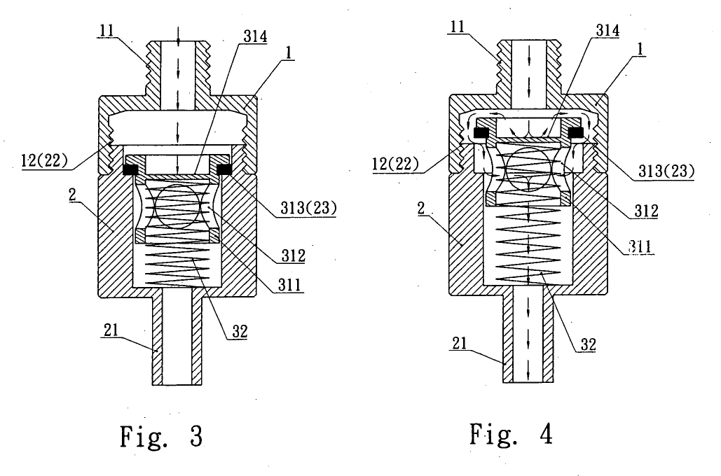

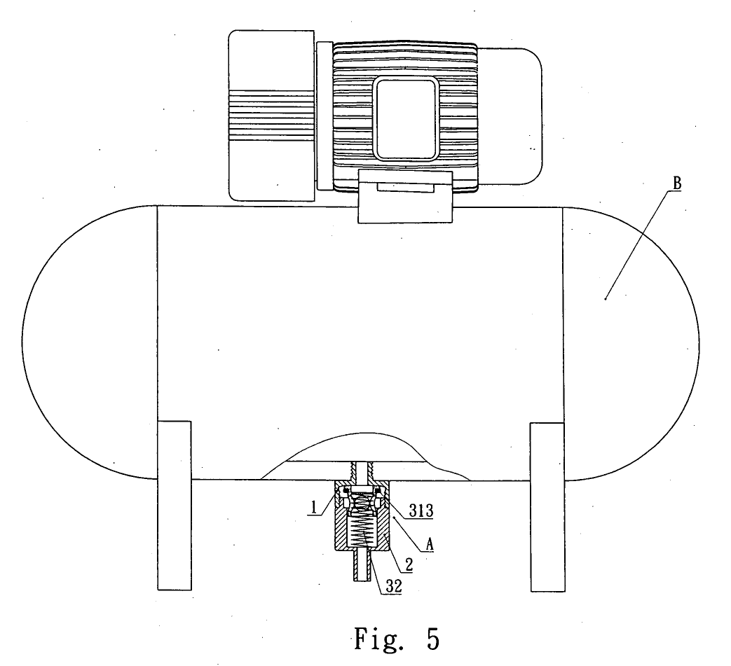

The operation of the present invention will be described with reference to FIGS. 3 to 5. When air is filled fully within the air compressor B, the air pressure in the air compressor B is larger than the elastic force of the check unit 3. The air pressure in the air compressor B will resist against the pressure accumulating groove 314 to directly resist against the check disk 31 so as to compress the spring 32. As a result the water-stop washer 313 of the check disk 31 is pressed by the spring 32 so as to resist against the stepped edge 23 of the receiving ring 2. Moreover, the internal space of the air compressor B is closed from the drain valve A to prevent air in the air compressor B from drainage, see FIG. 3. When the air compressor B is used, pressure in the cylinder will be released. When the pressure is smaller than the resisting force of the spring 32 of the check unit 3, the water-stop washer 313 of the check unit 3 will be pushed by the resilient force of the spring 32 so as to separate from the stepped edge 23 of the receiving ring 2. Then, the air compressor B is communicable to the drain valve A so as to drain the wasted water and impurities in the air compressor B, see FIG. 4. Thus, the present invention has a simple structure, can be installed easily. The draining of the air compressor B is performed automatically without using electric power.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An auto-drain valve of an air compressor; the auto-drain valve installed at a lower end of an air compressor for draining wasted water within the air compressor; the auto-drain valve comprising:
a retaining ring locked at the lower end of the air compressor;
a receiving ring locked to a lower end of the retaining ring; one end portion of the receiving ring being extended with a water outlet; an inner surface of the receiving ring being formed with a stepped edge;
a check unit received within the retaining ring and the receiving ring; the stepped edge of the receiving ring serving for confining the check unit as a pressure is applied to the check unit; one end of the check unit being protruded with a small annular surface; a spring being arranged within the small annular surface; a water-stop washer being formed upon the stepped edge; a check disk being placed above the small annular surface; a pressure accumulating groove being formed at an upper side of the check disk; when the air pressure within the air compressor being greater than resisting force of the spring, the air pressure in the air compressor will compress the spring; meanwhile, the water-stop washer of the check disk being pressed by the spring so as to resist against the stepped edge of the receiving ring for preventing air in the air compressor from draining out.

2. The auto-drain valve of an air compressor as claimed in claim 1, wherein a through hole for passing wasted water is formed in the small annular surface.

3. The auto-drain valve of an air compressor as claimed in claim 1, wherein the pressure accumulating groove and the inner space of the retaining ring being formed with a closed space.
